(19) United States
(12) Patent Application Publication
(10) Pub. No.: US 2020/0305490 A1
(43) Pub. Date: Oct. 1, 2020

(54) INGREDIENT, A METHOD OF PREPARING THE INGREDIENT AND A METHOD OF PREPARING A FOOD PRODUCT WITH THE INGREDIENT

(71) Applicant: Shigetoshi NAKAMURA, New York, NY (US)

(72) Inventor: Shigetoshi NAKAMURA, New York, NY (US)

(21) Appl. No.: 16/833,105

(22) Filed: Mar. 27, 2020

Related U.S. Application Data
(60) Provisional application No. 62/825,311, filed on Mar. 28, 2019.

(51) Int. Cl. A23L 35/00; A23L 5/30; A23L 5/10; A23L 3/36; A23L 23/00

(52) U.S. Cl. CPC A23L 35/10; A23L 5/30; A23L 23/00; A23L 3/36; A23L 5/13

(57) ABSTRACT

Disclosed are a food ingredient, a method of preparing the food ingredient, and a method of food preparation with the food ingredient, the food ingredient being animal-based or vegetable-based, including at least 25% by volume of a fat that can form an emulsion with a steam application, and having a viscosity in the range 80,000 to 100,000 centipoise at 25° C.

### CROSS-REFERENCE TO RELATED APPLICATIONS

The present application claims priority to U.S. Provisional Application Ser. No. 62/825,311, filed Mar. 28, 2019, the entire disclosure of which is incorporated by reference herein.

### FIELD OF THE INVENTION

The present disclosure relates to an ingredient, a method of preparing the ingredient, and a method of on-demand preparation of a consumable food product using the ingredient.

### BACKGROUND OF THE INVENTION

Broth is used in the preparation of certain food products, for example, Japanese ramen noodle dishes.

Traditional preparation of broth (called Tonkotsu) for use in a Japanese ramen noodle dish, for example, Tontoro ramen noodle, requires blanching pork bones, covering the blanched pork bones with cold water, and boiling at a hard boil for a minimum of 15 hours.

Japanese style ramen noodle shops are well known. In order to service customers, for example, for a day, a Japanese ramen noodle shop must prepare the broth for a single serving in advance in that it is not possible to prepare the broth in a reasonable amount of time on an order by order (on-demand) basis using the traditional method of broth preparation. Thus, a Japanese noodle shop would typically need to estimate the expected volume of orders in a day and prepare the expected volume accordingly. If more orders are received than expected, not all orders can be filled, which is a loss of business opportunity for the shop. If less orders are received than expected, then the extra broth may need to be discarded, which is a loss of product to the shop. Furthermore, keeping the broth for a day or more may vary its quality adversely, which is not desirable.

Thus, it has been a long felt need to devise a method that would permit preparation of fresh broth, on-demand (i.e. upon receiving an order) for making, for example, a traditional Japanese ramen dish without the disadvantages described above.

The use of steam in continuous and high volume cooking of soups and sauces at an industrial, high volume scale is known. This type of steam-based cooking is suited for factories and is considered an industrial process, not an on-demand process. Typically, industrial steam cooking involves rapid cooking of large volumes of ingredients, which may be uncooked, with high speed steam. Specifically, the process includes creating an environment of vaporized product that is surrounded by high energy steam through the provision of supersonic steam flow to heat suspended particles by surface conduction and condensation.

### SUMMARY OF THE INVENTION

The disclosure relates to an ingredient for making a food product, a method for making the ingredient, an ingredient made with the ingredient-making method, and a method for making a food product using the ingredient.

According to one embodiment, the ingredient, and the method for making a food product using the ingredient, allow for the on-demand, single serving preparation of a broth under a minute that can be used to make a food product immediately thereafter.

A method of food preparation, according to the present invention, includes depositing in a receptacle 60 to 120 grams of an ingredient that comprises at least 25% of fat by volume, the fat being capable of forming an emulsion, adding soup stock to said ingredient, and emulsifying the ingredient and the stock with steam to form a broth.

The ingredient may have no more than 50% of the fat by volume.

The ingredient may be an animal-based product.

The ingredient may be a vegetable-based product.

The ingredient may have a viscosity in the range 80,000 to 100,000 centipoise at 25° C.

The steam may be supplied at ambient atmospheric pressure.

The emulsifying may be carried out for less than one minute to form the broth.

A food product, according to the present invention may include a packet or a container, and a food ingredient in the packet or the container, the food ingredient having 25% by volume of a fat that is capable of forming an emulsion with a steam application, and having a viscosity in the range of 80,000 to 100,000 centipoise at 25° C.

The food product may have 60 to 120 grams of the ingredient in the packet or the container. The ingredient may have no more than 50% of the fat by volume, may be animal-based, or vegetable-based.

A method of making an ingredient, according to the present invention may include cooking an edible product, pulverizing the cooked edible product, chilling the pulverized cooked edible product to form a paste having a viscosity in the range 80,000 to 100,000 centipoise at 25° C., and a fat content by volume of at least 25%, the fat being capable of forming an emulsion with a steam application, and packaging the chilled, pulverized animal product.

The method may include packaging 60 to 120 grams of the chilled, pulverized cooked edible product.

The chilled, pulverized edible product may have no more than 50% of the fat by volume, may be animal-based, or vegetable-based.

Other features and advantages of the present invention will become apparent from the following description of the invention which refers to the accompanying drawings.

### BRIEF DESCRIPTION OF THE DRAWINGS

FIG. 1 shows the steps in an embodiment of a method according to the present invention for the preparation of a food product using an ingredient prepared according to an embodiment of the present invention.

FIG. 2 shows the steps in a method for the preparation of an ingredient according to an embodiment of the present invention.

FIG. 3 schematically shows a chiller apparatus that may be used in the method shown in FIG. 2.

### DETAILED DESCRIPTION OF THE INVENTION

The present invention relates to a food ingredient, prepared and configured for the preparation of a food product involving an emulsification step using steam.

The food ingredient may be prepared using an animal product. For example, the ingredient may be prepared using a porcine product, a bovine product, a sheep product, a fish product or a poultry product.

The animal product used should have animal fat. For example, the animal product should have a minimum fat content of 25%, and may have up to 50% fat content by volume.

The ingredient may also be prepared using non-animal, vegetable-based products such as peanuts, pistachios, or the like product that contains a substantial amount of fat.

According to the present invention, the product chosen for the preparation of the ingredient should have the type of fat that can be infused with water using a steam emulsification process as described below.

In a process according to the first embodiment of the present invention, an ingredient, prepared according to an embodiment of the present invention, is used to make a broth for a traditional Japanese ramen noodle dish, namely Tontoro ramen noodle.

The ingredient used in the first embodiment is a porcine-based product which is prepared to have the viscosity of a paste at room temperature (25° C.), i.e. a viscosity in the range 80,000-100,000 “centipoise”.

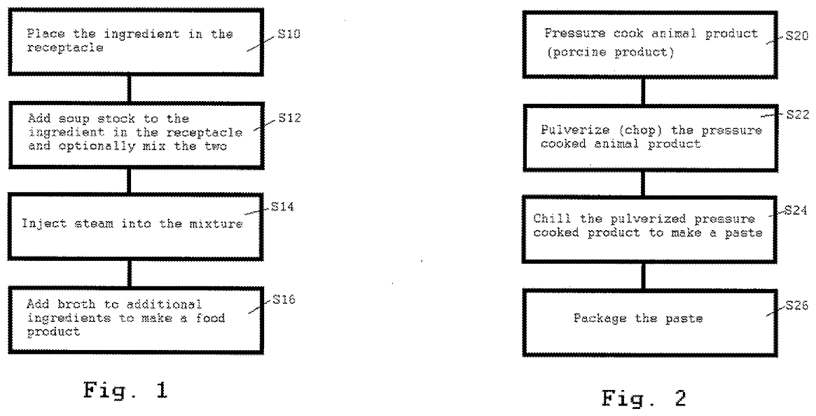

Referring to FIG. 1, a method of preparation of a food product according to one embodiment includes placing the ingredient in a receptacle (e.g. a cup) S10, adding soup stock to the ingredient in the receptacle S12 and optionally mixing the two, injecting steam into the mixture S14 to obtain a broth, and adding the broth to other ingredients to obtain a food product S16. The steps S10-S14 set forth in FIG. 1 can be carried out on an on-demand basis (for example, when an order is received from a customer) to make a broth for a single serving.

To prepare the broth for one serving, for example, 3.5 ounces of the ingredient is added to about six ounces of a chicken soup stock. A suitable chicken stock may be prepared by simmering, for 12 hours, in a 100 quart stock pot, the following:

80 lbs (chicken neck, back, breast bones, and some skin)

25 L water

500 g ginger

400 g kombu

The ingredient and the chicken stock are preferably deposited in, for example, a cup (e.g. a stainless steel frothing pitcher) and mixed gently with a spoon, for example, for less than twenty seconds. Thereafter, steam is used to prepare an emulsion of the ingredient and the chicken stock mixture to obtain a broth. The broth so made can be then mixed with any desired combination of additional ingredients. For example, to prepare Tontoro, the following ingredients may be used: Tare (soy sauce, other flavors), schmaltz (chicken fat, or other rendered animal fats), garlic paste (essentially pureed garlic), scallion, 180 g of noodles, Toppings, such as, menma/bamboo shoots, spinach, chashu pork (pork belly blanched, rolled, sliced, dipped in soy sauce and sugar solution, grilled until char marks form over volcanic rock), and pickled red cabbage. The additional ingredients are added while the broth remains in the heated state (i.e. after emulsification) to make a food product.

The inventor has discovered that, with an ingredient prepared according to the present invention, the steam from a wand (or spout) of a conventional milk frother can be used to obtain an emulsion suitable for use as a broth in the preparation of a food product as described, under atmospheric pressure, at a relatively low temperature, and in less than a minute. Thus, using an ingredient prepared according to the present invention, one may prepare a broth for a food product on an order by order (on-demand), single serving basis, thereby reducing the amount of potential waste associated with the traditional method and avoiding the opportunity losses associated with the traditional method, when a method according to the present invention is used in a commercial setting (e.g. a restaurant). The amount of ingredient for a single serving may be in the range of 60 grams to 120 grams.

A steam supplier that can be used (for example, a steam frother called Astra Pro Steamer) in a process according to the present invention produces steam at a relatively low temperature of 212° F./100° C., which is a minimum temperature needed to create steam at 132.26 PSI. The foregoing values are about the average pressure and the average temperature of steam produced by a conventional espresso machine. The steam is not provided at supersonic speed. As a consequence, a broth prepared according to the present invention may be prepared and served in a restaurant environment immediately without concern for safety of the staff and the consumer.

According to one embodiment of the present invention, the steam supplier may be equipped with a pressure regulator to set the pressure of the steam to a pressure in the range of 50-150 psi, or the preferred range of 90-140 psi. Outside of 50 psi or 150 psi the mixture may not properly emulsify. While the temperature of the broth may vary, the broth prepared according to the present invention needs to reach a minimum temperature of 208.4° F./98° C. to emulsify the paste as the steam moves through the paste. At the minimum temperature, the paste will be fully emulsified under a minute and ready to be used as a broth. If overheated, the fat will leach out of the emulsion. Thus, the temperature should be kept below 212° F./100° C. and above 208.4° F./98° C. to ensure that the fat will remain within the emulsion.

According to another embodiment of the present invention, the steam supplier may be equipped with a steam supply rate regulator to permit reducing or increasing the rate of supply (i.e. speed) of the steam to the mixture. The rate of the supply of steam can be used to adjust the degree of emulsification that can be achieved under a minute on an order-by-order (on-demand) basis.

Thus, a steam supplier as discussed can allow for the control of steam temperature and steam speed to vary the quality of the broth.

The steam may be supplied via a tube or a wand inserted into the mixture, which is retained in an open-mouth receptacle (e.g. a cup).

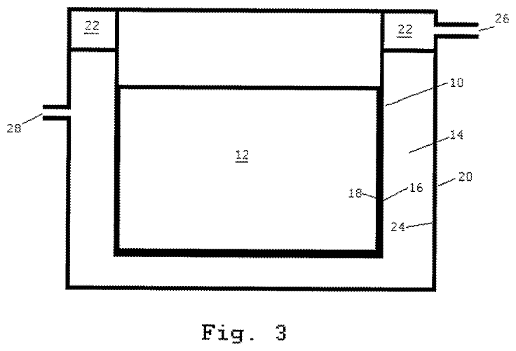

Referring to FIG. 2, an ingredient suitable for making a broth on-demand can be prepared based on an animal product, for example, a porcine product. The animal product may be first pressure cooked S20. The pressure-cooked animal product is then pulverized (chopped) S22 to obtain a paste. The pulverized (chopped) pressure-cooked product is then chilled S24. The chilled, pulverized, pressure-cooked animal product is then packaged S26.

An ingredient according to the first embodiment may be based on a porcine product and is prepared by pressure cooking 11 kg of pork belly (with the skin on) in 2.3 kg of water at 15 psi of pressure. As the pork belly, Berkshire pork belly (with the skin on) may be used. After the cooking step, the fat is rendered out of the pressure-cooked pork belly and the pressure-cooked product is pulverized (chopped finely) into a paste-like mass. An All-Clad K275OD may be used to pulverize/chop the pressure-cooked pork belly in two minutes. The paste so obtained is then chilled for one hour. To chill the paste, the paste is placed in a water-cooled chiller apparatus, while being mixed, for example, with a “SAKI Automatic Pot Mixer” (a conventional pot mixer) on high speed, whereby the paste may be homogenized.

Referring to FIG. 3, the chiller apparatus may include a receptacle 10 that receives the paste 12, which is water-cooled using, for example, running water 14 supplied around the exterior surface 16 of the wall 18 of the receptacle 10. For this purpose, the receptacle may be placed in another receptacle 20, bucket or tub, and running water 14 may be supplied to the space 22 between the receptacle 10 that contains the paste 14 and the interior wall 24 of the receptacle 20 in which the receptacle 10 is received. The water may be provided to space 22 via an input pipe 26 and extracted via an output pipe 28 to keep the water moving to ensure that the temperature of the cooling water remains substantially the same in the temperature range of 40°-50° F. The paste must be cooled from 120° F. to 70° F. in less than two hours, and must be cooled from 70° F. to 45° in less than an additional four hours. The temperature of the running water may be 4.5° C./40° F. in the winter, 7° C./50° F. in the summer, which may depend upon the location of the available water (reservoir vs. aquifer and even the distance from the equator). Once cooled, the paste may be deposited into smaller containers and kept cold in a freezer. Also, conventional preservatives may be added to the paste as required before packing. In one preferred embodiment, the paste may be packaged for preparation of a single serving. The amount of paste for a single serving may be in the range 60 grams to 120 grams. The preferred minimum amount of paste for a single serving may be at a minimum 100 g and at a maximum 120 g. Optionally, the single serving package may be hermetically sealed to improve its shelf life. Optionally, the paste may be pasteurized using any suitable method. A suitable packaging, for example, may be a flexible, squeezable packet made of a plastic or metallic foil typically used for a single serving of salad dressing.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of food preparation, comprising:
depositing in a receptacle 60 to 120 grams of an ingredient that comprises at least 25% of fat by volume, the fat being capable of forming an emulsion;
adding soup stock to said ingredient; and
emulsifying the ingredient and the stock with steam to form a broth.

2. The method of claim 1, wherein the ingredient comprises no more than 50% of the fat by volume.

3. The method of claim 1, wherein the ingredient is animal-based.

4. The method of claim 1, wherein the ingredient is vegetable-based.

5. The method of claim 1, wherein the ingredient has a viscosity in the range 80,000 to 100,000 centipoise at 25° C.

6. The method of claim 1, wherein the steam is supplied at ambient atmospheric pressure.

7. The method of claim 1, wherein the emulsifying is carried out for less than one minute to form the broth.

8. The method of claim 2, wherein the ingredient has a viscosity in the range 80,000 to 100,000 centipoise at 25° C.

9. The method of claim 8, wherein the steam is supplied at ambient atmospheric pressure.

10. The method of claim 9, wherein the emulsifying is carried out for less than one minute to form the broth.

11. A food product, comprising:
a packet or a container; and
a food ingredient in the packet or the container, the food ingredient having 25% by volume of a fat that is capable of forming an emulsion with a steam application, and having a viscosity in the range of 80,000 to 100,000 centipoise at 25° C.

12. The food product of claim 11, wherein 60 to 120 grams of the ingredient is in the packet or the container.

13. The method of claim 12, wherein the ingredient comprises no more than 50% of the fat by volume.

14. The method of claim 12, wherein the ingredient is animal-based.

15. The method of claim 12, wherein the ingredient is vegetable-based.

16. A method of making an ingredient, comprising:
cooking an edible product;
pulverizing the cooked edible product;
chilling the pulverized cooked edible product to form a paste having a viscosity in the range 80,000 to 100,000 centipoise at 25° C., and a fat content by volume of at least 25%, the fat being capable of forming an emulsion with a steam application; and
packaging the chilled, pulverized animal product.

17. The method of claim 16, wherein 60 to 120 grams of the chilled, pulverized cooked animal product is packaged.

18. The method of claim 16, wherein the chilled, pulverized edible product comprises no more than 50% of the fat by volume.

19. The method of claim 16, wherein the edible product is animal-based.

20. The method of claim 16, wherein the edible product is vegetable-based.
